(19) United States
(12) Patent Application Publication
(10) Pub. No.: US 2013/0097929 A1
(43) Pub. Date: Apr. 25, 2013

(54) Process for Producing Hydrogen

(71) Applicants: Hoanh Nang Pham, Allentown, PA (US); Eugene S. Genkin, Allentown, PA (US)

(72) Inventors: Hoanh Nang Pham, Allentown, PA (US); Eugene S. Genkin, Allentown, PA (US)

(73) Assignee: Air Products and Chemicals, Inc., Allentown, PA (US)

(21) Appl. No.: 13/455,241

(22) Filed: Apr. 25, 2012

Related U.S. Application Data
(60) Provisional application No. 61/618,051, filed on Mar. 30, 2012.

(51) Int. Cl. C01B 3/40

(52) U.S. Cl. 48/198.7; 48/197 FM

(57) ABSTRACT

A process for producing a hydrogen-containing product gas with reduced carbon dioxide emissions compared to conventional hydrogen production processes. A hydrocarbon and steam are reformed in a reformer and the resulting reformate stream is shifted in at least two shift reactors. The shifted mixture is separated to form a CO₂ product stream, the hydrogen-containing product gas, and a pressure swing adsorption tail gas. A fuel gas comprising the pressure swing adsorption tail gas and a supplemental fuel are combusted in the reformer furnace. The H₂ concentration in the fuel gas ranges from 35 volume % to 70 volume % and the supplemental fuel provides 5% to 15% of the firing rate.

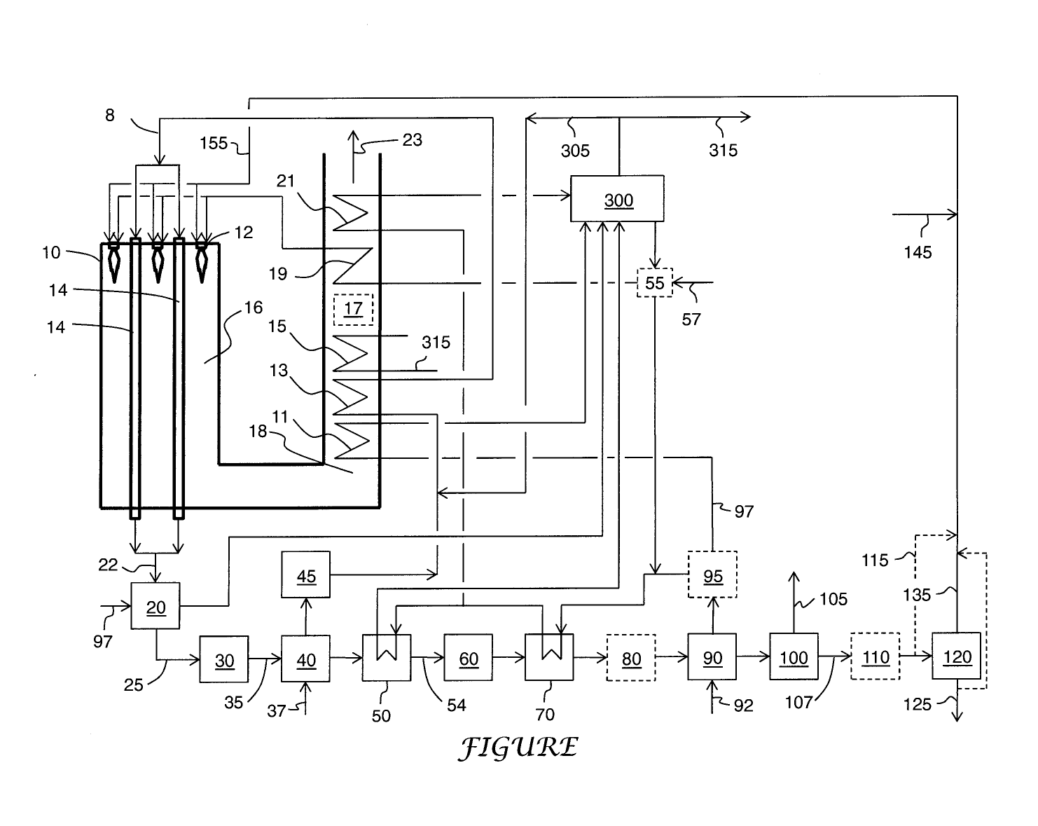

### BACKGROUND

There is growing pressure to reduce carbon dioxide emissions from industrial processes. A large hydrogen production plant may produce up to 900,000 metric tons of carbon dioxide per year, thus it may be considered a significant source of carbon dioxide.

In Europe, Canada, and California, carbon dioxide reduction regulations are being phased in gradually. This means that greenhouse gas (GHG) legislation remains a key consideration in projects in the 2012-2015 timeframe. The current understanding on this issue is that new plants will have to plan for carbon dioxide capture but may not be required to install and operate such systems at the project on-stream date. Therefore, industry desires a flexible carbon dioxide capture ready design that may be implemented when needed.

Industry desires to produce hydrogen by steam-hydrocarbon reforming while capturing carbon dioxide thereby decreasing or eliminating carbon dioxide emissions.

Industry desires to adjust the amount of carbon dioxide capture based on regulations and economics.

Industry desires an energy efficient large-scale hydrogen production process with decreased carbon dioxide emissions compared to conventional processes.

### BRIEF SUMMARY

The present invention relates to a process for producing a hydrogen-containing product gas.

There are several aspects of the process as outlined below.

Aspect 1. A process comprising:
(a) introducing a process stream comprising steam and at least one hydrocarbon selected from the group consisting of methane, ethane, propane, butane, pentane, and hexane into a plurality of catalyst-containing reformer tubes in a reformer furnace and reacting the process stream inside the plurality of catalyst-containing reformer tubes at a first temperature ranging from 700° C. to 960° C. and a first pressure ranging from 1.0 MPa to 3.5 MPa to form a reformate stream comprising hydrogen, carbon monoxide, methane, and steam and withdrawing the reformate stream from the plurality of catalyst-containing reformer tubes;
(b) reacting the reformate stream from step (a) in the presence of a first shift catalyst comprising iron oxide at a second temperature ranging from 330° C. to 450° C. and a second pressure ranging from 1.0 MPa to 3.5 MPa thereby forming additional H₂ and CO₂ in the reformate stream;
(c) cooling the reformate stream from step (b);
(d) reacting the reformate stream from step (c) in the presence of a second shift catalyst comprising copper at a third temperature ranging from 190° C. to 340° C. and a third pressure ranging from 1.0 MPa to 3.5 MPa thereby decreasing the CO concentration in the reformate stream to less than 2% (dry) volume %;
(e) separating the reformate stream from step (d) to form a CO₂ product stream, the hydrogen-containing product gas, and a pressure swing adsorption tail gas comprising H₂, CO, and CH₄; and
(f) combusting a fuel gas comprising the pressure swing adsorption tail gas and a supplemental fuel in the reformer furnace external to the plurality of catalyst-containing reformer tubes at a firing rate to supply energy for reacting the process stream inside the plurality of catalyst-containing reformer tubes, and withdrawing a flue gas from the reformer furnace;
wherein the H₂ concentration in the fuel gas ranges from 35 volume % to 70 volume % and the supplemental fuel provides 5% to 15% of the firing rate.

Aspect 2. The process of aspect 1 wherein the step of separating the reformate stream comprises:
(e1) separating the reformate stream from step (d) to form a CO₂-depleted stream and the CO₂ product stream; and
(e2) separating at least a portion of the CO₂-depleted stream by pressure swing adsorption to form the hydrogen-containing product gas and the pressure swing adsorption tail gas.

Aspect 3. The process of aspect 2 wherein the reformate stream is separated in step (e1) by pressure swing adsorption.

Aspect 4. The process of aspect 2 wherein the reformate stream is separated in step (e1) by scrubbing the reformate stream with a wash stream to form the CO₂-depleted stream and a CO₂-loaded wash stream and wherein the CO₂ product stream is formed from the CO₂-loaded wash stream.

Aspect 5. The process of any one of aspects 2-4 wherein the fuel gas further comprises at least one of (i) a second portion of the CO₂-depleted stream not separated by pressure swing adsorption, and (ii) a portion of the H₂-containing product gas.

Aspect 6. The process of any one of aspects 1-4 wherein the fuel gas further comprises a portion of the H₂-containing product gas.

Aspect 7. The process of any one of aspects 2-4 wherein the fuel gas further comprises a second portion of the CO₂-depleted stream.

Aspect 8. The process of any one of aspects 1-7 wherein the first shift catalyst further comprises chromium oxide.

Aspect 9. The process any one of aspects 1-8 wherein the second shift catalyst further comprises at least one of zinc oxide, aluminum oxide, and chromium oxide.

Aspect 10. The process of any one of aspects 1-9 wherein a feed steam is heated by indirect heat exchange with the reformate stream in step (c), wherein the feed stream comprises the at least one hydrocarbon, and wherein the process stream is formed from the feed stream.

Aspect 11. The process of any one of aspects 1-10 wherein water for producing steam is heated by indirect heat exchange with the reformate stream in step (c).

Aspect 12. The process of any one of aspects 1-11 further comprising heating water for producing steam by indirect heat exchange with the reformate stream from step (d) thereby cooling the reformate stream prior to step (e).

Aspect 13. The process of any one of aspects 1-12 wherein the process stream does not comprise the pressure swing adsorption tail gas; and wherein no pressure swing adsorption tail gas is introduced into the reformate stream between step (a) and step (b).

### BRIEF DESCRIPTION OF SEVERAL VIEWS OF THE DRAWINGS

The FIGURE is a process flow diagram of an exemplary embodiment of the process for producing a hydrogen-containing product gas.

### DETAILED DESCRIPTION

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity. The term “and/or” placed between a first entity and a second entity means one of (1) the first entity, (2) the second entity, and (3) the first entity and the second entity. The term “and/or” placed between the last two entities of a list of 3 or more entities means at least one of the entities in the list.

As used herein, “plurality” means at least two.

The phrase “at least a portion” means “a portion or all.” The at least a portion of a stream may have the same composition as the stream from which it is derived. The at least a portion of a stream may include specific components of the stream from which it is derived.

As used herein a “divided portion” of a stream is a portion having the same chemical composition as the stream from which it was taken.

As used herein, the term “catalyst” refers to a support, catalytic material, and any other additives which may be present on the support.

The term “depleted” means having a lesser mole % concentration of the indicated gas than the original stream from which it was formed. “Depleted” does not mean that the stream is completely lacking the indicated gas.

For the purposes of simplicity and clarity, detailed descriptions of well-known devices, circuits, and methods are omitted so as not to obscure the description of the present invention with unnecessary detail.

The present invention relates to a process for producing a hydrogen-containing product gas. The process is particularly useful for producing a hydrogen-containing product gas with reduced carbon dioxide emissions compared to conventional steam/hydrocarbon reforming processes.

The process is described with reference to the exemplary embodiment illustrated in the FIGURE.

The process comprises introducing a process stream 8 comprising steam and at least one hydrocarbon selected from the group consisting of methane, ethane, propane, butane, pentane, and hexane into a plurality of catalyst-containing reformer tubes 14 in a reformer furnace 10, reacting the process stream inside the plurality of catalyst-containing reformer tubes at a first temperature ranging from 700° C. to 960° C. and a first pressure ranging from 1.0 MPa to 3.5 MPa to form a reformate stream 22 comprising hydrogen, carbon monoxide, methane, and steam, and withdrawing the reformate stream 22 from the plurality of catalyst-containing reformer tubes 14.

As used herein, a reformate stream is any stream comprising hydrogen and carbon monoxide formed from the reforming reaction of a hydrocarbon and steam.

The process stream 8 may contain more than one hydrocarbon. The process stream may be initially formed from natural gas and steam, liquefied petroleum gas (LPG) and steam, naphtha and steam and/or other feedstocks known in the art. The process stream 8 may be processed in a prereformer prior to introducing the process stream 8 into the plurality of catalyst-containing reformer tubes 14.

Reformer furnaces with a plurality of catalyst-containing reformer tubes, i.e. tubular reformers, are well known in the art. Suitable materials and methods of construction are known. Catalyst in the catalyst-containing reformer tubes may be any suitable catalyst known in the art, for example, a supported catalyst comprising nickel.

The reformate stream 22 withdrawn from the plurality of catalyst-containing reformer tubes 14 may be cooled in a heat exchanger 20. Heat exchanger 20 may be a process gas boiler to produce steam from water 97 by indirect heat transfer and thereby remove heat from reformate stream 22. Reformate stream 22 may be passed to heat exchanger 20 to remove heat from the reformate stream and improve the thermal efficiency of the process.

The reformate stream is passed to high temperature shift reactor 30. The process further comprises reacting the reformate stream in the presence of a first shift catalyst comprising iron oxide at a second temperature ranging from 330° C. to 450° C. and a second pressure ranging from 1.0 MPa to 3.5 MPa thereby forming additional H₂ and CO₂ in the reformate stream. The first shift catalyst is a high temperature shift catalyst. The first shift catalyst may further comprise chromium oxide. Suitable high temperature shift catalysts are commercially available.

The reformate is cooled after the high temperature shift. The reformate may be cooled in heat exchanger 40 where a hydrocarbon feed stream 37 is heated by indirect heat exchange with the reformate stream. Water for producing steam may be heated by indirect heat exchange with the reformate in heat exchanger 50 thereby cooling the reformate. Heated water is passed to steam drum 300 where vapor and liquid are separated. Steam is withdrawn from steam drum 300 and separated into process steam 305, which is used in the reforming process, and export steam 315, which is exported to another process.

After heating, the hydrocarbon feed stream 37 is passed to a desulphurization unit 45 to remove sulfur. Steam 305 is mixed with the desulphurized hydrocarbon feed stream, the mixed feed heated in heat exchanger 13 in the convection section 18 of reformer 10, and passed as the process stream 8 to the plurality of catalyst-containing tubes 14 of reformer 10.

The reformate stream 54 is passed to low temperature shift reactor 60. The process further comprises reacting the reformate stream in the presence of a second shift catalyst comprising copper at a third temperature ranging from 190° C. to 340° C. and a third pressure ranging from 1.0 MPa to 3.5 MPa thereby decreasing the CO concentration in the reformate stream to less than 2 (dry) volume % (often to less than 1%. The second shift catalyst may be referred to as a low temperature shift catalyst. The second shift catalyst may further comprise at least one of zinc oxide, aluminum oxide, and chromium oxide. Suitable low temperature shift catalysts are commercially available.

After shifting in the shift reactor 60, the reformate may be cooled by heat exchange with water for forming steam in heat exchanger 70. The reformate may be further cooled in water heater 90. Water 92 may be heated by indirect heat exchange with reformate and passed to deaerator 95.

The process further comprises separating the reformate stream to form a CO₂ product stream 105, the hydrogen-containing product gas 125, and a pressure swing adsorption tail gas comprising H₂, CO, and CH₄. Pressure swing adsorption tail gas may also comprise N₂. The reformate stream may be separated into the various streams by a variety of unit operations.

The reformate stream may be separated into the various streams by pressure swing adsorption as described, for example, in U.S. Pat. No. 4,171,206, U.S. Pat. No. 4,790,858, U.S. Pat. No. 4,869,894, U.S. Pat. No. 4,963,339, U.S. Pat. No. 5,000,925, U.S. Pat. No. 5,133,785, U.S. Pat. No. 7,550,030, U.S. Pat. No. 7,618,478, and U.S. Pat. No. 7,740,688.

Alternatively, as shown in the FIGURE, the reformate stream may be separated into the CO₂ product stream, the hydrogen-containing product gas, and the pressure swing adsorption tail gas by first separating the reformate stream to form a CO₂-depleted stream 107 and the CO₂ product stream 105, then separating at least a portion of the CO₂-depleted stream 107 by pressure swing adsorption to form the hydrogen-containing product gas 125 and the pressure swing adsorption tail gas 135.

The reformate stream may be separated to form the CO₂-depleted stream 107 and the CO₂ product stream 105 by pressure swing adsorption. Alternatively, the reformate stream may be separated to form the CO₂-depleted stream 107 and the CO₂ product stream 105 by scrubbing the reformate stream with a wash stream to form the CO₂-depleted stream and a CO₂-loaded wash stream. The CO₂ product stream is formed from the CO₂-loaded wash stream.

Scrubbing may be done in a so-called gas scrubber 100. Carbon dioxide scrubbing is also known in the art as acid gas removal. The wash stream may be any scrubbing fluid known in the art, for example N-methyl diethanolamine (aMDEA). Other scrubbing fluids associated with other scrubbing methods, for example, MEA, Benfield, Rectisol®, Selexol®, Genosorb®, and sulfinol are known in the art.

Heat for gas scrubber 100 may be provided by the reformate stream in heat exchanger 80.

The term “depleted” means having a lesser mole % concentration of the indicated component than the original stream from which it was formed. This means that carbon dioxide-depleted stream has a lesser mole % concentration of carbon dioxide than the reformate that was introduced into the scrubber 100. The wash stream, having an affinity for carbon dioxide will become “loaded” with carbon dioxide. Carbon dioxide will become absorbed or otherwise taken in by the wash stream.

The carbon dioxide-depleted stream contains only a small amount of carbon dioxide.

Water may also be removed from the reformate prior to the gas scrubber 100 and/or in the gas scrubber 100.

The temperature of the CO₂-depleted stream may be conditioned in temperature conditioner 110 before being passed to pressure swing adsorber 120. Construction and operation of pressure swing adsorbers are known in the art. Suitable devices and operating conditions may be selected by one skilled in the art.

Simpler and less efficient pressure swing adsorbers and their associated processes may be used since a portion of the hydrogen-containing product gas 125 may be blended with the pressure swing adsorption tail gas 135 for use as a fuel 155 in the reformer furnace 10.

Fuel gas 155 is passed to burners 12. Fuel gas comprises the pressure swing adsorption tail gas 135 and the supplemental fuel 145. The process comprises combusting fuel gas 155 comprising the pressure swing adsorption tail gas 135 and supplemental fuel 145 in the reformer furnace external to the plurality of catalyst-containing reformer tubes at a firing rate to supply energy for reacting the process stream inside the plurality of catalyst-containing reformer tubes 14. The pressure swing adsorption tail gas may be preheated by heat exchange with the reformate stream and/or the flue gas or by other means. The fuel gas may comprise a portion of the ft-containing product gas 125. The fuel gas may comprise a second portion 115 of the CO₂-depleted stream.

The H₂ concentration in the fuel gas ranges from 35 volume % to 70 volume % and the supplemental fuel provides 5% to 15% of the firing rate.

Air 57 for combustion is heated in heat exchanger 55 and further heated in heat exchanger 19 in the convection section of the reformer before being passed to burners 12.

Flue gas 23 is withdrawn from the reformer furnace 10, and because the fuel gas 155 comprises less CO and CH₄ than conventional reformer furnaces, the flue gas will contain a reduced amount of CO₂ compared to conventional reformer furnaces. The amount of CO₂ emissions in the flue gas 23 can be adjusted by the amount of hydrogen in the fuel gas 155 and the percentage of the total firing rate provided by the supplemental fuel 145.

The supplemental fuel 145 is often called trim fuel and may be, for example, natural gas.

The firing rate is a common term used in the art. As used herein, the firing rate is the net heating value, HV, of a stream multiplied by the flow rate, F, (using consistent units). The percentage of the firing rate provided by the supplemental fuel is the product of the flow rate of the supplemental fuel 145, F_{SF}, and the heating value of the supplemental fuel, HV_{SF}, divided by the product of the flow rate of the fuel gas 155, F_{FG}, and the heating value of the fuel gas, HV_{FG}, the quantity multiplied by 100%:

$$\% Supplemental Fuel Firing Rate = \frac{{F}_{SF} \times {HV}_{SF}}{{F}_{FG} \times {HV}_{FG}} \times 100 \% .$$

The flue gas may provide heat for various process streams in the convection section 18 of the reformer 10 and may be subjected to a catalyst 17 for selective catalytic reduction to reduce NOx emissions. As shown in the FIGURE, water is heated in heat exchanger 11 to make steam. Feed to the plurality of catalyst-containing tubes is heated in heat exchanger 13. Export steam 315 is superheated in heat exchanger 15. Combustion air is heated in heat exchanger 19. Water is pre-heated in heat exchanger (economizer) 21 before being sent to steam drum.

The process can provide about 75% carbon capture from the plant with only small efficiency losses compared to CO₂ removal and up to 80% carbon capture with some efficiency penalty.

1. A process for producing a hydrogen-containing product gas, the process comprising:
(a) introducing a process stream comprising steam and at least one hydrocarbon selected from the group consisting of methane, ethane, propane, butane, pentane, and hexane into a plurality of catalyst-containing reformer tubes in a reformer furnace and reacting the process stream inside the plurality of catalyst-containing reformer tubes at a first temperature ranging from 700° C. to 960° C. and a first pressure ranging from 1.0 MPa to 3.5 MPa to form a reformate stream comprising hydrogen, carbon monoxide, methane, and steam and withdrawing the reformate stream from the plurality of catalyst-containing reformer tubes;
(b) reacting the reformate stream from step (a) in the presence of a first shift catalyst comprising iron oxide at a second temperature ranging from 330° C. to 450° C. and a second pressure ranging from 1.0 MPa to 3.5 MPa thereby forming additional H₂ and CO₂ in the reformate stream;
(c) cooling the reformate stream from step (b);
(d) reacting the reformate stream from step (c) in the presence of a second shift catalyst comprising copper at a third temperature ranging from 190° C. to 340° C. and a third pressure ranging from 1.0 MPa to 3.5 MPa thereby decreasing the CO concentration in the reformate stream to less than 2 volume % on a dry basis;
(e) separating the reformate stream from step (d) to form a CO₂ product stream, the hydrogen-containing product gas, and a pressure swing adsorption tail gas comprising H₂, CO, and CH₄; and
(f) combusting a fuel gas comprising the pressure swing adsorption tail gas and a supplemental fuel in the reformer furnace external to the plurality of catalyst-containing reformer tubes at a firing rate to supply energy for reacting the process stream inside the plurality of catalyst-containing reformer tubes, and withdrawing a flue gas from the reformer furnace;
wherein the H₂ concentration in the fuel gas ranges from 35 volume % to 70 volume % and the supplemental fuel provides 5% to 15% of the firing rate.

2. The process of claim 1 wherein the step of separating the reformate stream comprises:
(e1) separating the reformate stream from step (d) to form a CO₂-depleted stream and the CO₂ product stream; and
(e2) separating at least a portion of the CO₂-depleted stream by pressure swing adsorption to form the hydrogen-containing product gas and the pressure swing adsorption tail gas.

3. The process of claim 2 wherein the reformate stream is separated in step (e1) by pressure swing adsorption.

4. The process of claim 2 wherein the reformate stream is separated in step (e1) by scrubbing the reformate stream with a wash stream to form the CO₂-depleted stream and a CO₂-loaded wash stream and wherein the CO₂ product stream is formed from the CO₂-loaded wash stream.

5. The process of claim 2 wherein the fuel gas further comprises at least one of (i) a second portion of the CO₂-depleted stream not separated by pressure swing adsorption, and (ii) a portion of the H₂-containing product gas.

6. The process of claim 1 wherein the fuel gas further comprises a portion of the H₂-containing product gas.

7. The process of claim 2 wherein the fuel gas further comprises a second portion of the CO₂-depleted stream.

8. The process of claim 1 wherein the first shift catalyst further comprises chromium oxide.

9. The process of claim 1 wherein the second shift catalyst further comprises at least one of zinc oxide, aluminum oxide, and chromium oxide.

10. The process of claim 1 wherein a feed steam is heated by indirect heat exchange with the reformate stream in step (c), wherein the feed stream comprises the at least one hydrocarbon, and wherein the process stream is formed from the feed stream.

11. The process of claim 1 wherein water for producing steam is heated by indirect heat exchange with the reformate stream in step (c).

12. The process of claim 1 further comprising heating water for producing steam by indirect heat exchange with the reformate stream from step (d) thereby cooling the reformate stream prior to step (e).

13. The process of claim 1 wherein the process stream does not comprise the pressure swing adsorption tail gas; and
wherein no pressure swing adsorption tail gas is introduced into the reformate stream between step (a) and step (b).
